(19) United States
(12) Patent Application Publication
(10) Pub. No.: US 2014/0146556 A1
(43) Pub. Date: May 29, 2014

(54) VEHICLE LAMP APPARATUS

(71) Applicant: Chung-Hsu Kao, Tainan City (TW)

(72) Inventor: Chung-Hsu Kao, Tainan City (TW)

(21) Appl. No.: 13/689,383

(22) Filed: Nov. 29, 2012

(51) Int. Cl. F21V 13/04

(52) U.S. Cl. CPC F21V 13/04
USPC 362/518

(57) ABSTRACT

A vehicle lamp apparatus includes a mounting seat, a light transmissive unit, a reflective unit and a light emitting unit. The light transmissive unit is mounted to the mounting seat and includes a partially reflective member disposed to face the mounting seat. The reflective unit is disposed opposite to the partially reflective member and includes a plurality of reflective ridges protruding toward the partially reflective member. The light emitting unit is configured to emit light that is reflected to and fro between the partially reflective member and the reflective ridges so as to generate a light beam refracted by and passing through the light transmissive unit with a particular visual effect.

### BACKGROUND OF THE INVENTION

1. Field of the Invention

The invention relates to a lamp apparatus, more particularly to a vehicle lamp apparatus.

2. Description of the Related Art

Referring to FIG. 1, U.S. Pat. No. 7,029,152 discloses a conventional vehicle lamp apparatus 1 that includes a housing 11, a two-way planar mirror 12 disposed in the housing 11 at one side of the housing 11, a one-way planar mirror 13 disposed at the other side of the housing 11 opposite to the two-way planar mirror 12 in the housing 11, and a plurality of light sources 141 arranged between the two-way planar mirror 12 and the one-way planar mirror 13.

The two-way planar mirror 12 includes a glass plate 121 coated with a reflecting surface 122 made of silver, and the one-way planar mirror 13 includes a partially reflective surface 131 facing the two-way planar mirror 12 and a translucent surface 132 opposite to the partially reflective surface 131. The light sources 141 are configured to emit light reflected to and fro between the partially reflective surface 131 and the reflecting surface 122 so as to generate a light beam refracted by and passing through the translucent surface 132.

### SUMMARY OF THE INVENTION

The object of the present invention is to provide a vehicle lamp apparatus that can provide a particular visual effect.

According to the present invention, there is provided a vehicle lamp apparatus including a mounting seat, a light transmissive unit, a reflective unit, and a light emitting unit. The light transmissive unit includes a main body mounted to and cooperating with the mounting seat to define a receiving space therebetween, and a partially reflective member disposed on the main body within the receiving space and facing the mounting seat. The reflective unit is disposed in the receiving space, is opposite to the partially reflective member in a first direction, and includes a main portion and a plurality of reflective ridges that protrude from the main portion toward the partially reflective member in the first direction, that extend in a second direction perpendicular to the first direction, and that are spaced apart from one another in a third direction perpendicular to the first and second directions. The light emitting unit is disposed in the receiving space and is configured to emit light that is reflected to and fro between the partially reflective member and the reflective ridges so as to generate a light beam refracted by and passing through the light transmissive unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional vehicle lamp apparatus disclosed in U.S. Pat. No. 7,029,152;

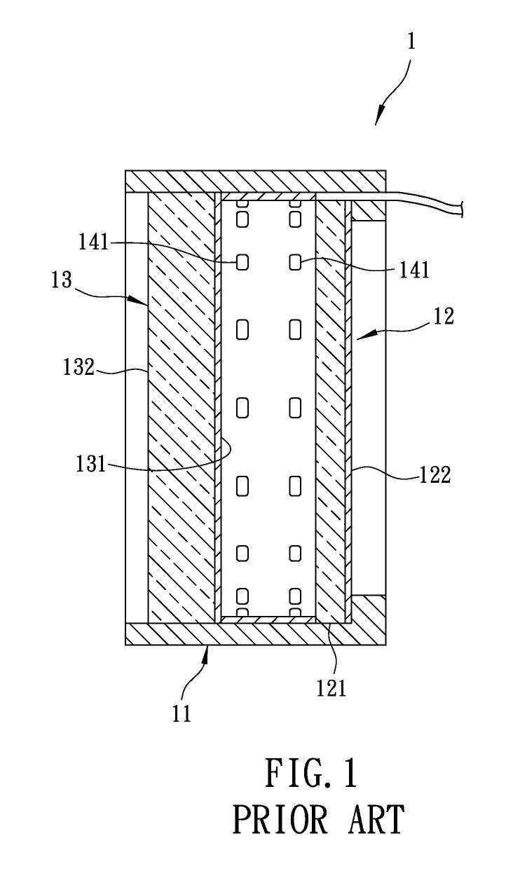

FIG. 2 is an exploded perspective view of a first preferred embodiment of a vehicle lamp apparatus according to the present invention;

FIG. 3 is a sectional view of the vehicle lamp apparatus of the first preferred embodiment;

FIG. 4 is a schematic front view of the vehicle lamp apparatus of the first preferred embodiment for illustrating visual effect of light beams emitted from the vehicle lamp apparatus;

FIG. 5 is an exploded perspective view of a second preferred embodiment of the vehicle lamp apparatus according to the present invention; and

FIG. 6 is a sectional view of the vehicle lamp apparatus of the second preferred embodiment.

### DETAILED DESCRIPTION OF THE PREFERRED EMBODIMENTS

Before the present invention is described in greater detail, it should be noted that same reference numerals have been used to denote like elements throughout the specification.

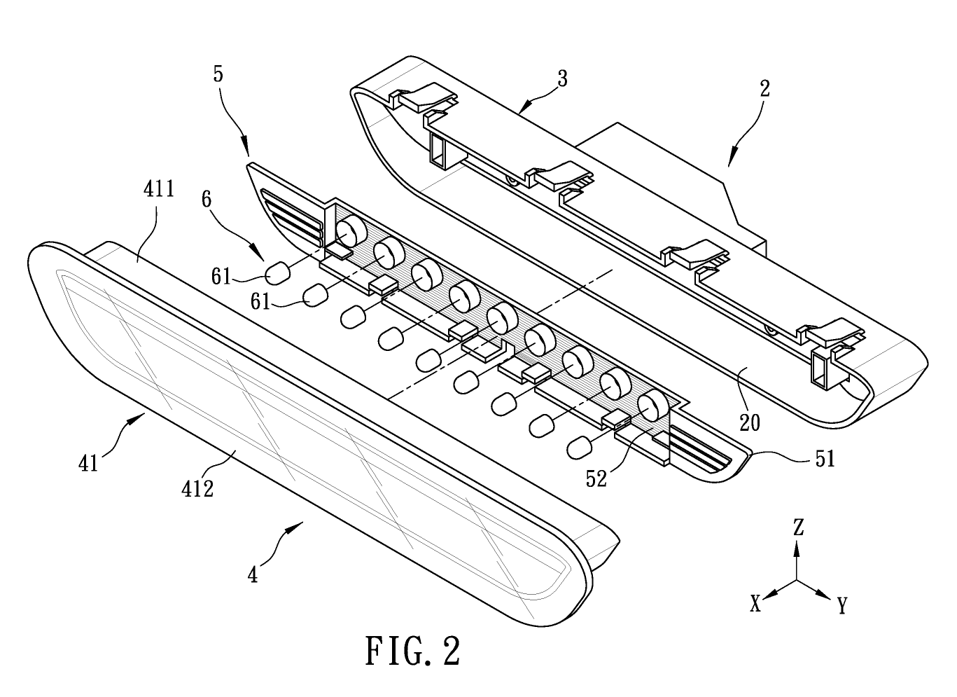

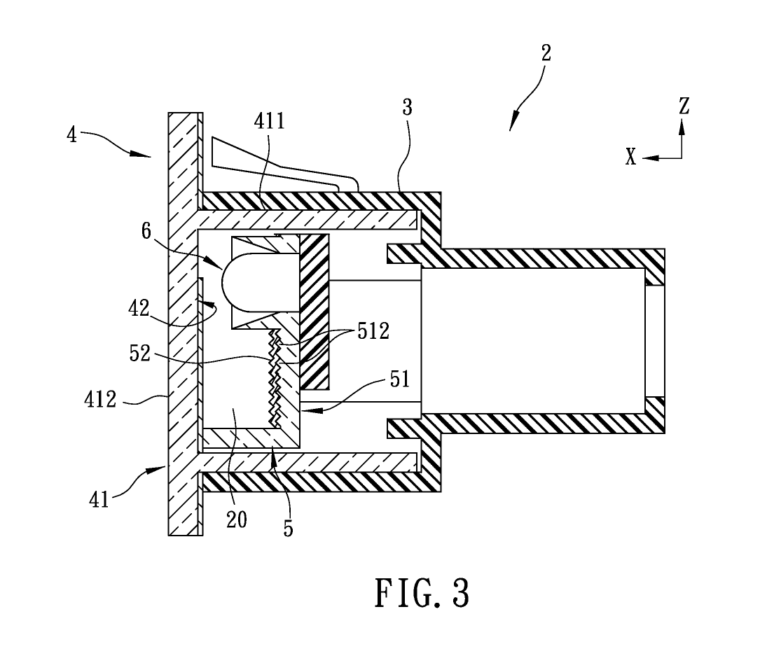

Referring to FIGS. 2 and 3, a first preferred embodiment of a vehicle lamp apparatus 2 according to the present invention is shown to include a mounting seat 3, a light transmissive unit 4, a reflective unit 5, and a light emitting unit 6.

The light transmissive unit 4 includes a main body 41 mounted to the mounting seat 3 and cooperating with the mounting seat 3 to define a receiving space 20 therebetween, and a partially reflective member 42. The main body 41 includes a coupling portion 411 coupled to the mounting seat 3, and a cover portion 412 connected to one end of the coupling portion 411 opposite to the mounting seat 3. The partially reflective member 42 is disposed on the cover portion 412 of the main body 41 within the receiving space 20, and faces the mounting seat 3. A portion of light emitted from the light emitting unit 6 may be reflected by the partially reflective member 42 while another portion of the light is refracted by and passes through the partially reflective member 42.

In this embodiment, the partially reflective member 42 is one of an aluminum coating and a chromium coating coated on the cover portion 412 of the main body 41.

The reflective unit 5 is disposed in the receiving space 20, is opposite to the partially reflective member 42 in a first direction (X), and includes a main portion 51 and a plurality of reflective ridges 512. The reflective ridges 512 protrude from the main portion 51 toward the partially reflective member 42 in the first direction (X), extend in a second direction (Y) perpendicular to the first direction (X), and are spaced apart from one another in a third direction (Z) perpendicular to the first and second directions (X, Y). Additionally, each of the reflective ridges 512 has a triangular cross-section viewed in the second direction (Y).

In this embodiment, the reflective ridges 512 are coated with a reflective layer 52, which is one of an aluminum coating and a chromium coating.

The light emitting unit 6 includes a plurality of light emitting members 61 disposed in the receiving space 20 and spaced apart from one another in the second direction (Y). Each of the light emitting members 61 is configured to emit light that is reflected to and fro between the partially reflective member 42 and the reflective ridges 512 so as to generate a light beam 200 refracted by and passing through the light transmissive unit 4 with a particular visual effect. In this embodiment, the light emitting members 61 are light-emitting diodes (LEDs).

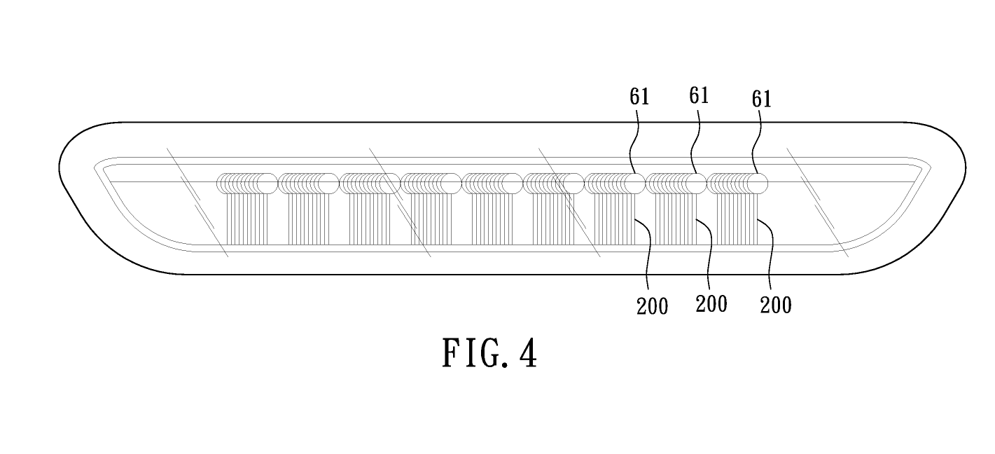

As shown in FIG. 4, regarding the visual effect of each light beam 200, illumination of the light beam 200 reduces gradually from the light emitting member 61. Furthermore, the arrangement of the light emitting members 61 is not limited to the disclosure of this embodiment and can be modified as desired.

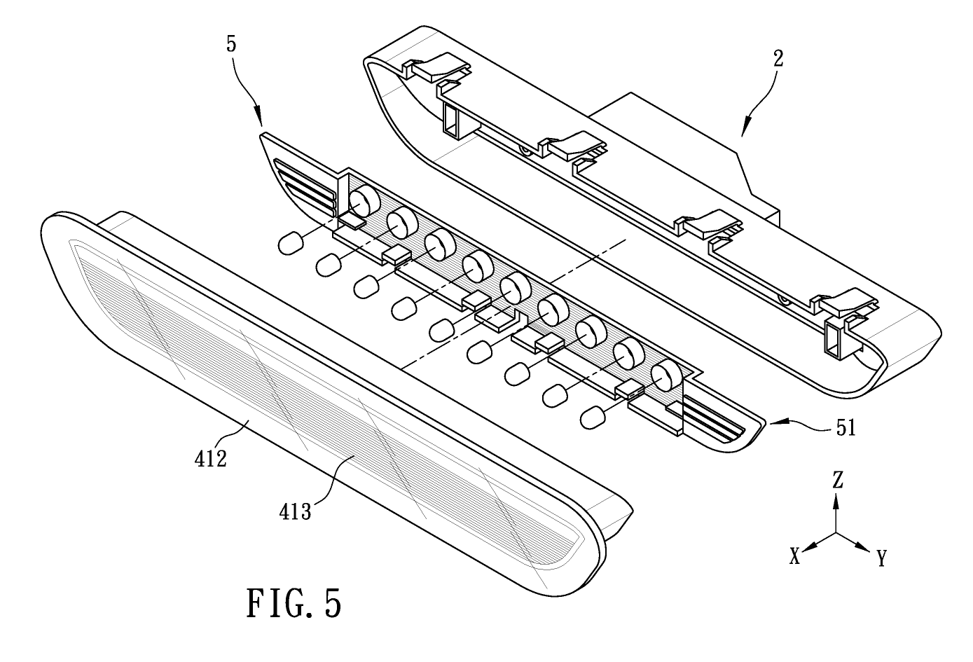

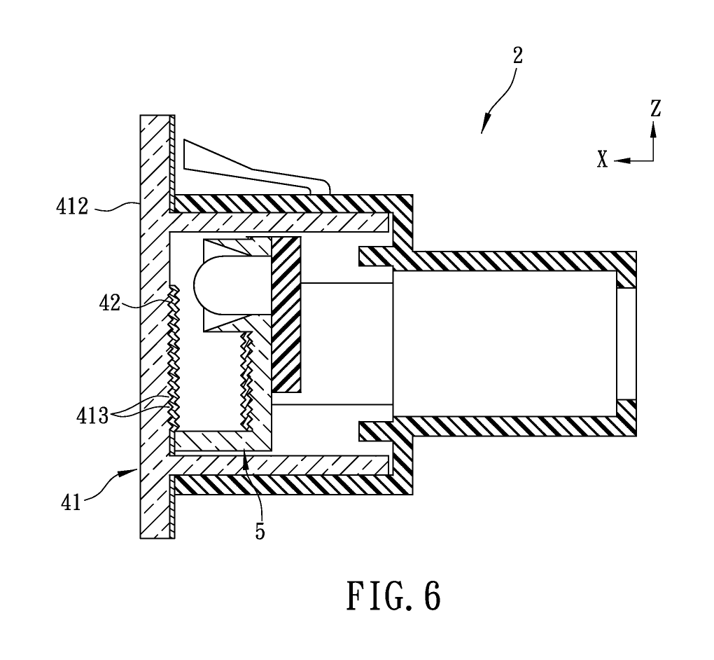

Referring to FIGS. 5 and 6, the second preferred embodiment of the vehicle lamp apparatus 2 of the present invention is shown. In this embodiment, the main body 41 of the light transmissive unit 4 further includes a plurality of protrusions 413 protruding from the cover portion 412 toward the reflective unit 5 in the first direction (X), extending in the second direction (Y), and spaced apart from one another in the third direction (Y). In this embodiment, the partially reflective member 42 is one of an aluminum coating and a chromium coating coated on the protrusions 413.

To sum up, by virtue of the configuration of the reflective ridges 512 of the reflective unit 5 and the partially reflective member 42 of the light transmissive unit 4, the vehicle lamp apparatus 2 of the present invention emits the light beams 200 with a particular visual effect.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A vehicle lamp apparatus comprising:
a mounting seat;
a light transmissive unit including
a main body mounted to and cooperating with said mounting seat to define a receiving space therebetween, and
a partially reflective member disposed on said main body within said receiving space and facing said mounting seat;
a reflective unit disposed in said receiving space, opposite to said partially reflective member in a first direction, and including a main portion and a plurality of reflective ridges that protrude from said main portion toward said partially reflective member in the first direction, that extend in a second direction perpendicular to the first direction, and that are spaced apart from one another in a third direction perpendicular to the first and second directions; and
a light emitting unit disposed in said receiving space, and configured to emit light that is reflected to and fro between said partially reflective member and said reflective ridges so as to generate a light beam refracted by and passing through said light transmissive unit.

2. The vehicle lamp apparatus as claimed in claim 1, wherein said main body of said light transmissive unit includes a coupling portion coupled to said mounting seat, and a cover portion connected to one end of said coupling portion opposite to said mounting seat.

3. The vehicle lamp apparatus as claimed in claim 2, wherein said main body of said light transmissive unit further includes a plurality of protrusions protruding from said cover portion toward said reflective unit in the first direction, extending in the second direction, and spaced apart from one another in the third direction, and said partially reflective member is coated on said protrusions.

4. The vehicle lamp apparatus as claimed in claim 1, wherein said light emitting unit includes a plurality of light emitting members spaced apart from one another in the second direction.

5. The vehicle lamp apparatus as claimed in claim 1, wherein said partially reflective member is one of an aluminum coating and a chromium coating.

6. The vehicle lamp apparatus as claimed in claim 1, wherein said reflective ridges are coated with a reflective layer, which is one of an aluminum coating and a chromium coating.
